(19) United States
(12) Patent Application Publication
(10) Pub. No.: US 2007/0289788 A1
(43) Pub. Date: Dec. 20, 2007

(54) Cleaning Cart

(75) Inventor: Dirk Salmon, Wertheim (DE)

Correspondence Address: WOLF GREENFIELD & SACKS, P.C., 600 ATLANTIC AVENUE, BOSTON, MA, 02210-2206, US

(73) Assignee: VERMOP Salmon Gmbh, Wertheim (DE)

(21) Appl. No.: 10/590,564

(22) PCT Filed: Feb. 21, 2005
(86) PCT No.: PCT/EP05/01776

§ 371 Date: May 7, 2007

(30) Foreign Application Priority Data
Feb. 24, 2004 (EP) 04004139.4

(51) Int. Cl. B62D 51/02

(52) U.S. Cl. 180/19.3

(57) ABSTRACT

The invention relates to a cleaning cart which comprises a base, at least three wheels mounted laterally or under the base and a structure, arranged over the base, for receiving cleaning utensils, as well as a handle. On the underside of the base at least one electric motor is functionally linked with a respective transmission which acts upon at least one of the wheels.

The present invention relates to a cleaning cart which comprises a base, at least three wheels mounted laterally or under the base and a structure, arranged over the base, for receiving cleaning utensils, as well as a handle.

This type of cleaning cart has long been known in various designs. The base, which is generally formed as a supporting platform or frame arrangement, can thereby consist of a plastic or metal plate or a metal tube construction.

The structure for receiving the cleaning utensils is mostly formed by a columnar construction or a rack arrangement made of steel tube, which may have various designs depending on the intended use and may often be assembled in the form of a modular system.

It is particularly when used in offices or hospitals that larger liquid containers such as buckets or troughs containing cleaning water or presses for wiping mops also need to be transported on the cleaning cart along with the cleaning utensils. The cleaning carts thus equipped are relatively heavy and have to be moved over longer distances, in particular when used in hospitals. This demands the use of a considerable amount of force and causes fatigue symptoms in cleaning staff, thus requiring a higher amount of time to be provided for the cleaning work.

Therefore, it is the object of the present invention to provide a cleaning cart which can be moved in a force-saving and fatigue-free manner, even when loaded heavily, while having a simple configuration.

According to the invention, this object is solved by arranging at least one electric motor, which is functionally linked with a respective transmission acting upon at least one of the wheels, on the underside of the base.

Transport carts for conveying loads, which are driven by an electric motor, form part of the basic equipment of industries. However, these are of a high technical complexity and have relatively large-volume drives. Such constructions are not suitable for use in cleaning carts due to the comparatively filigree design of cleaning carts and given that the cleaning utensils need to be arranged according to ergonomic considerations so as to attain a fatigue-free use, and thus there is no space available for conventional drives.

It is already known to provide electric drives in hand-guided carts such as golf carts, baby carriages or shopping trolleys (cf. for instance DE 199 09 020). However, such electric drives are mostly arranged in the central axis of the drive wheel for reasons of space, i.e. these are designed as so-called “hub drives”. Due to the small amount of space required in the hub area, this presupposes complex constructions and, in particular, transmission arrangements which are relatively expensive and thus also unsuitable for use in cleaning carts.

The invention is based on the concept of providing a type of “underfloor construction” that uses that space under the base which is necessary for the required ground clearance of the cleaning cart anyway and requires as little space as possible in the region of the structure arranged over the base, instead of conventional, heavy industrial drives or complex wheel hub drives.

It is advantageous to also mount the accumulator arrangement required as energy storage means on the underside of the base along with the electric motor(s) and the respective transmission arrangements linked therewith. However, depending on the intended use and the operation period, the accumulator arrangement may optionally be arranged in the region of the upper side of the base among the cleaning utensils.

In principle, any suitable controller can be provided for controlling the electric motor(s). It is thus possible to provide, for instance, a thrust sensor supplying the electric motor(s) with power from the accumulator arrangement whenever the operator exerts a pushing force on the handle or the cart. However, a particularly simple and cost-efficient construction is obtained when the control arrangement connected to the electric motor(s) and the accumulator arrangement is made up of a simple operating device disposed in the region of the handle, which may comprise, for instance, a slider control, a turning handle, a joystick or the like as a control element.

In principle, three wheels are sufficient for the drive operation of such a cleaning cart. However, it is advantageous to provide four wheels arranged under the base, with two wheels being fixed and two wheels being designed as what is known as castor wheels.

The wheels can fundamentally be arranged in any manner. However, it is advantageous—when seen in the driving direction—to arrange the fixed wheels approximately at the centre of the cart in the region of the side edges of the base and to arrange one movable wheel centrally in each of the regions of the front edge and the rear edge of the base.

A particularly simple construction as well as an optimum arrangement in terms of the position of the centre of gravity is achieved by arranging the heavy members of the drive, such as the electric motor, the transmission arrangement and the accumulator arrangement, approximately at the centre under the base, i.e. the platform or frame arrangement. Various configurations are possible in this regard, depending on the system selected. A particularly flat arrangement which only reduces the ground clearance slightly is achieved by arranging two electric motors, each functionally linked with one of the fixed wheels via a respective transmission, approximately at the centre of the base.

However, it is also possible to arrange only one electric motor approximately at the centre of the base and to couple it with the fixed wheels via a transmission with differential.

So as to facilitate the charging of the accumulator arrangement after the cleaning and drive operation, it is expedient to arrange what is known as a “docking rail” in the marginal region of the base, i.e. the platform or frame arrangement. The operator will thus merely have to connect the docking rail to a charging rail fixedly arranged on a wall or the like in the parking station of the cleaning cart, which charging rail will connect the accumulator arrangement to a stationary charging device via contractors.

When using a cleaning cart as according to the invention in ample buildings such as airports, train stations or hospitals, the travel path from the parking station to the place of application will frequently be several hundred metres long and, in particular cases, several kilometres long.

In such cases, it is advantageous to equip the base of the cleaning cart with standing means for an operator.

In principle, said standing means can have various designs. For instance, the standing means may be integrated in the base.

However, it is particularly advantageous to design the standing means as a standing platform which can be attached to the base, said standing platform being in turn equipped with wheels.

So as to further illustrate and facilitate the understanding of the invention, an exemplary embodiment thereof will now be described in greater detail and explained by referring to the enclosed drawings.

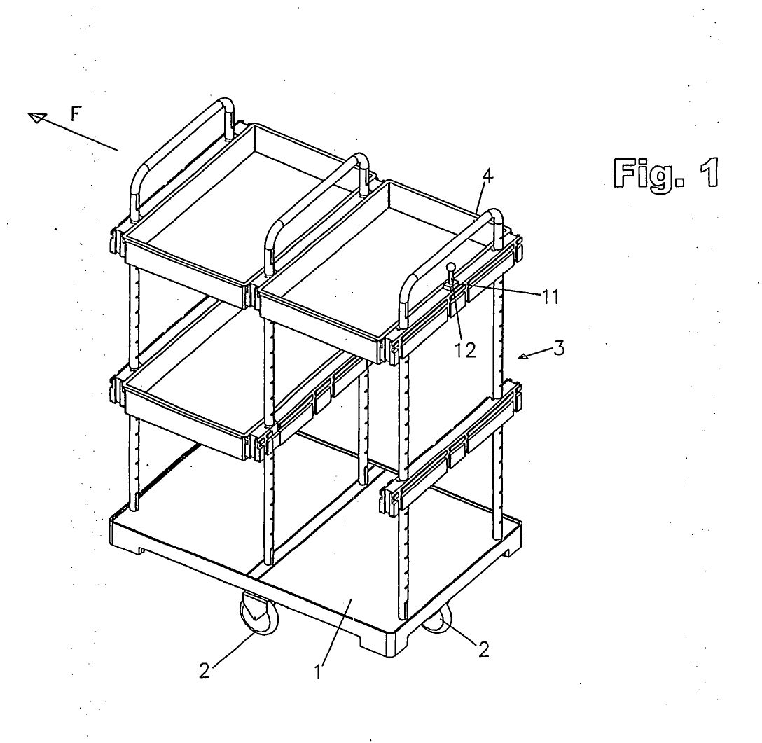

FIG. 1 shows a perspective view of a cleaning cart comprising a base in the form of a platform as well as a structure for receiving cleaning utensils,

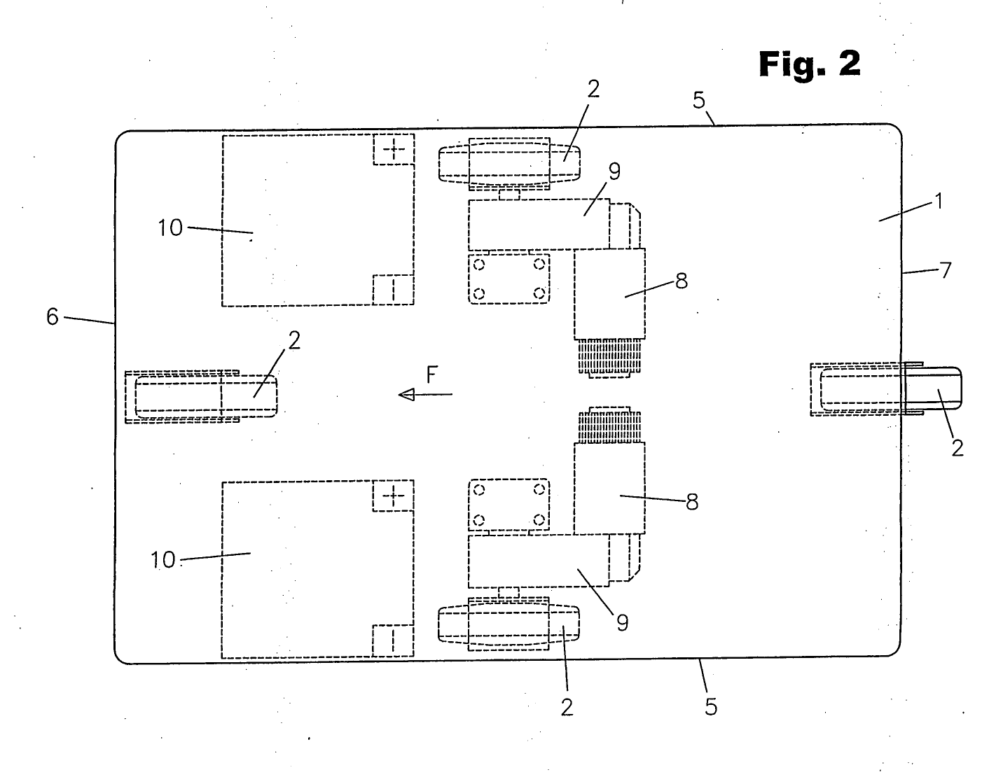

FIG. 2 shows the platform of the cleaning cart (without the structure) in a top view, with the members and the arrangement of the drive being represented by dotted lines,

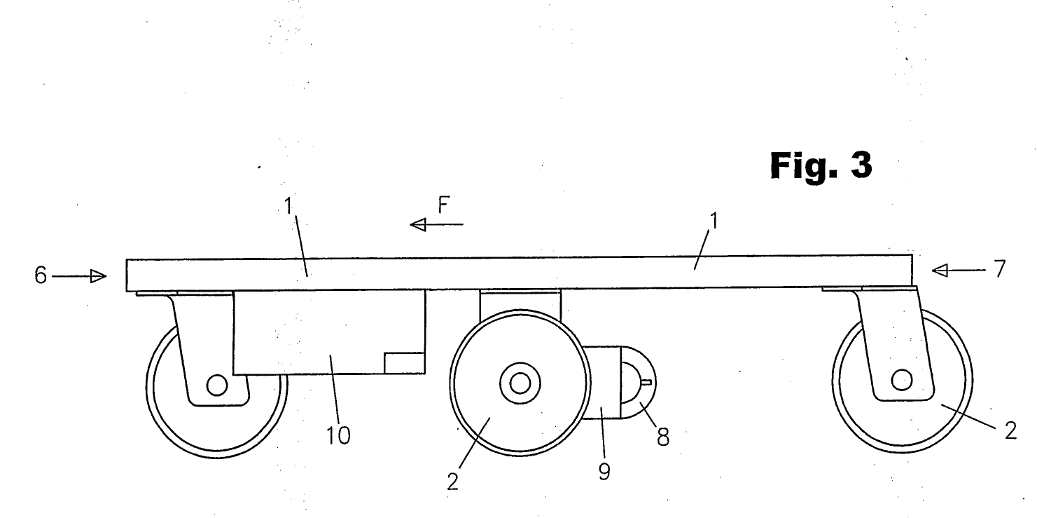

FIG. 3 shows a side view of the platform (without the structure) from a bottom perspective, and

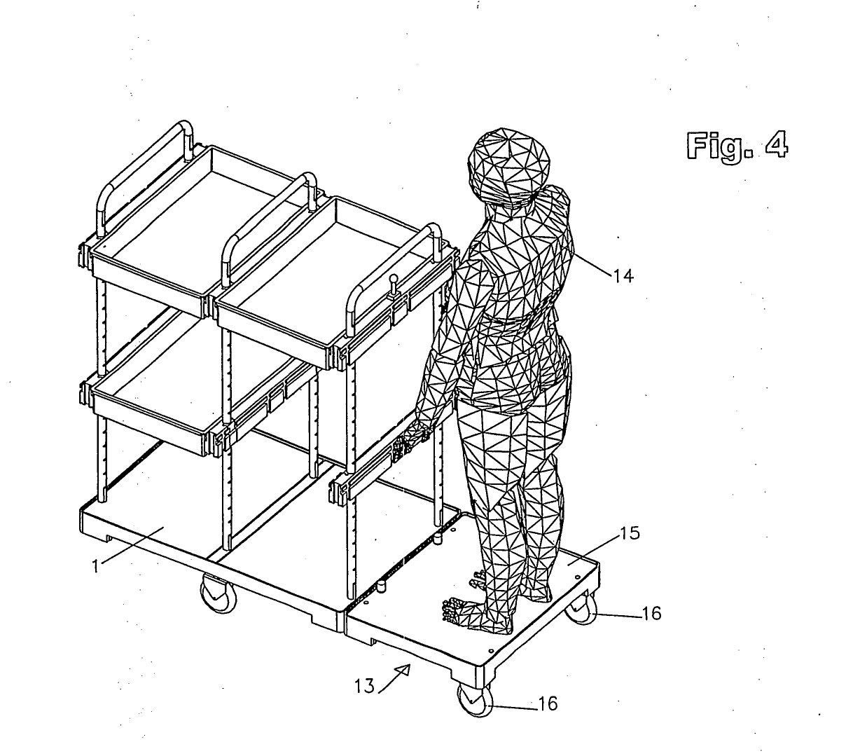

FIG. 4 shows a cleaning cart comprising standing means for an operator in a perspective view according to FIG. 1.

As revealed by FIG. 1, the cleaning cart consists of a base in the form of a platform 1, wheels 2 arranged under said platform 1, as well as a structure 3 arranged over said platform 1, which is merely shown partly assembled and unloaded, i.e. without cleaning utensils, for the sake of clarity.

In the present exemplary embodiment, the structure 3 is equipped with a handle 4 in the form of a hand grip.

As revealed in particular by FIG. 2, the illustrated cleaning cart has a total of four wheels 2, with two fixed wheels 2 being arranged at the centre of the cart in the region of the side edges 5 and one movable wheel being arranged centrally in each of the regions of the front edge 6 and the rear edge 7 of said platform 1, when seen in the driving direction F.

The illustrated exemplary embodiment comprises a drive having two electric motors 8, each functionally linked with the allocated fixed wheel 2 in the region of the side edges 5 via a transmission 9. The wheels 2 arranged centrally in the region of the front edge 6 and the rear edge 7 are steerable.

In the present exemplary embodiment, an accumulator arrangement comprising two accumulators 10 is also arranged on the underside of said platform 1.

In the illustrated exemplary embodiment, the electric motors 8 are connected to the accumulators 10 via an electronic control arrangement (not shown). Said control arrangement is connected to an operating device 11 (FIG. 1) arranged in the region of the handle 4 and comprising a joystick 12 via which the rotational speed of the two electric motors can be controlled independently of each other in a manner known per se.

In the exemplary embodiment as shown in FIG. 4, the cleaning cart according to the invention is equipped with standing means 13 for an operator 14.

In this exemplary embodiment, said standing means 13 is formed by a standing platform 15 for the operator 14, with said standing platform being attachable to the base 1 of the cleaning cart using a suitable coupling device (not shown).

The standing platform 15 is equipped with separate wheels 16 transferring the main load of the weight of the operator 14 to the ground.

The arrangement shown in FIG. 4 has the advantage that the cleaning cart can be converted for each application in a relatively rapid and simple manner.

1. A cleaning cart comprising:
a base;
at least three wheels mounted to the base;
a structure, arranged over the base, for receiving cleaning utensils;
a handle; and
at least one electric motor functionally linked to a transmission and acting upon at least one of the wheels, the motor being arranged on the underside of the base.

2. The cleaning cart according to claim 1, further comprising an accumulator arrangement mounted on the underside of the base.

3. The cleaning cart according to claim 2, further comprising a control arrangement connected to the at least one electric motor and the accumulator arrangement is provided therein, which comprises an operating device proximate to the handle.

4. The cleaning cart according to claim 1, wherein the at least three wheels comprises four wheels arranged under the base, with two wheels being fixed and two wheels being steerable.

5. The cleaning cart according to claim 4, wherein, when seen in the driving direction, the fixed wheels are arranged approximately at a center of the cart in the region of side edges of the base and one movable wheel is arranged centrally in each of a front edge region and a rear edge region of the base.

6. The cleaning cart according to claim 5, wherein the at least one electric motor comprises two electric motors, each functionally linked with a fixed wheel via a transmission, and each arranged approximately at the center of the base.

7. The cleaning cart according to claim 5, wherein the at least one electric motor, is arranged approximately at a center of the base, and wherein the motor is functionally linked to the fixed wheels via a transmission having differential.

8. The cleaning cart according to claim 3, wherein the handle comprises a hand grip and the operating device comprises a joystick arranged proximate the hand grip.

9. The cleaning cart according to claim 3, wherein the accumulator arrangement comprises a docking rail arranged in a marginal region of the base.

10. The cleaning cart according to claim 3, wherein the base comprises a stand for an operator.

11. The cleaning cart according to claim 10, wherein the stand is integrated in the base.

12. The cleaning cart according to claim 10, wherein the stand comprises a standing platform having wheels, the standing platform being attachable to the base.
